(19) United States
(12) Patent Application Publication
(10) Pub. No.: US 2025/0357551 A1
(43) Pub. Date: Nov. 20, 2025

(54) AQUEOUS ELECTROLYTE COMPOSITION AND AQUEOUS SECONDARY BATTERY COMPRISING SAME

(71) Applicant: DAEGU GYEONGBUK INSTITUTE OF SCIENCE AND TECHNOLOGY, Daegu (KR)

(72) Inventors: Ho Chun LEE, Daegu (KR); Suk Hyung LEE, Asan-si (KR)

(21) Appl. No.: 18/860,757

(22) PCT Filed: Mar. 3, 2023
(86) PCT No.: PCT/KR2023/002891

§ 371 Date: Jul. 29, 2025

(30) Foreign Application Priority Data
May 6, 2022 (KR) 10-2022-0056063

(51) Int. Cl. H01M 10/26

(52) U.S. Cl. CPC H01M 10/26; H01M 2300/0014

(57) ABSTRACT

The aqueous electrolyte composition according to various embodiments of the present invention comprises a first additive, a second additive, and an aqueous electrolyte, wherein the first additive and the second additive are different to each other in terms of reduction reaction potential. The aqueous secondary battery according to various embodiments of the present disclosure may include the aforementioned aqueous electrolyte composition.

### TECHNICAL FIELD

Various embodiments of the present invention relate to an aqueous electrolyte composition and an aqueous secondary battery comprising the same. Specifically, various embodiments of the present invention relate to an aqueous electrolyte composition containing two types of additives that perform different functions, respectively, and an aqueous secondary battery comprising the same.

### BACKGROUND ART

Since aqueous secondary batteries employ aqueous electrolytes instead of flammable organic electrolytes, the safety issues of secondary batteries can be solved, and strict moisture management in the manufacturing process is not required, so that the aqueous secondary batteries have relatively high price competitiveness.

However, aqueous electrolytes have the drawback of being more prone to oxidative/reductive decomposition compared to organic electrolytes. In other words, due to the narrow electrochemical stability window (ESW), the charging voltage of aqueous secondary batteries is restricted (<2 V), resulting in a much lower energy density compared to existing secondary batteries, which is a significant drawback.

To overcome this drawback of aqueous electrolytes, a highly concentrated aqueous electrolyte (water-in-salt electrolyte, WiSE) using an excess of salt (salt-to-water mole ratio>1/3) has been proposed.

In WiSE, the reductive decomposition of anions is promoted to facilitate the formation of a protective layer (solid electrolyte interphase, SEI) on the anode surface, and this SEI suppresses an additional hydrogen evolution reaction (HER) of water. Also, the low activity of water in WiSE suppresses an oxygen evolution reaction (OER) of water at a cathode. Therefore, it has been reported that the charging voltage of aqueous secondary batteries employing WiSE significantly increases (>2V).

However, aqueous secondary batteries, even when employing WiSE, still show poor cycle life characteristics and severe self-discharge issues compared to existing secondary batteries, and these problems are further accelerated at high temperatures.

These attribute to the insufficient durability of the anode SEI formed by WiSE. The SEI formed by WiSE is primarily composed of inorganic components (LiF, Li₂O, Li₂CO₃, etc.), and this SEI composed of inorganic components exhibits high electrical insulation and excellent HER suppression. However, this SEI composed of inorganic components is easily dissolved in electrolytes and gest lost due to the high solubility in aqueous solutions. Moreover, under high-temperature conditions, the solubility of the inorganic components increases, resulting in more severe SEI dissolution/loss issues.

As an extended concept of WiSE, a water-in-bisalt electrolyte (WiBSE) case where two types of salts are mixed to further increase the maximum salt concentration or an aqueous and non-aqueous hybrid electrolyte case where an organic solvent or an ionic liquid is used as a co-solvent has been reported.

The WiBSE and hybrid electrolyte fail to provide a sufficient solution although they can somewhat reduce SEI dissolution/loss issues. Moreover, with the increase in salt concentration and introduction of an organic solvent, the WiBSE and hybrid electrolyte significantly reduce the ion transport rate in the electrolyte, causing a deterioration in rate capability of secondary batteries. Additionally, the WiBSE and hybrid electrolyte have an issue of increased material costs.

A case has been reported where an Al₂O₃ layer is formed on the anode surface through atomic layer deposition (ALD) to improve the anode characteristics in aqueous secondary batteries. However, the performance enhancement is insufficient and the added ALD process brings an increase in cost.

A case has also been reported where an organic polymer SEI is formed on the anode surface by applying a polymer monomer as an electrolyte additive. However, the suppression effect of the organic polymer SEI on HER is insufficient, resulting in an insignificant improvement in battery performance.

### DETAILED DESCRIPTION OF THE INVENTION

### Technical Problem

Various embodiments of the present invention have been derived to solve the above-described problems, and an aspect of the present invention is to provide an aqueous electrolyte composition capable of significantly enhancing the performance of aqueous secondary batteries and an aqueous secondary battery containing the same.

### Technical Solution

Aqueous electrolyte compositions according to various embodiments of the present invention contain: a first additive; a second additive; and an aqueous electrolyte, wherein the first additive and the second additive have different reduction potentials.

Aqueous secondary batteries according to various embodiments of the present invention may contain the above-described aqueous electrolyte compositions.

### Advantageous Effects

According to the present invention, the formation of a double-layered SEI layer is expected by mixing of two types of additives in the aqueous electrolyte composition, and this double-layered SEI layer can lead to blocking of HER and minimizing of SEI dissolution/lost, thereby achieving high capacity retention ratio, residual capacity ratio, and columbic efficiency of aqueous secondary batteries.

### BRIEF DESCRIPTION OF THE DRAWINGS

FIG. 1 is a schematic diagram of an aqueous secondary battery containing an aqueous electrolyte composition according to an embodiment of the present invention.

FIG. 2 shows electrochemical stability window (ESW) results through cyclic voltammetry (CV) measurement measurement of aqueous electrolyte compositions of Example 1 and Comparative Examples 1 to 3 of the present invention.

FIG. 3 shows room-temperature charging and discharging results and coulombic efficiency measurement results of LMO/LTO batteries employing aqueous electrolyte compositions of Example 1 and Comparative Examples 1 to 3.

### MODE FOR CARRYING OUT THE INVENTION

Hereinafter, various embodiments of the present disclosure are described with reference to the accompanied drawings. It should be understood that embodiments and terminologies used herein are not intended to limit the technology described in the present disclosure to particular forms of embodiments, but to cover various modifications, equivalents, and/or alternatives of corresponding embodiments.

Hereinafter, various embodiments of the present disclosure will be described in detail with reference to the accompanying drawings.

An aqueous electrolyte composition according to various embodiments of the present invention may contain a first additive, a second additive, and an aqueous electrolyte.

The first additive may be a compound that forms radicals through an electrochemical reduction reaction. Specifically, the first additive may be at least one selected from the group consisting of a persulfate-based compound, a peroxide-based compound, and an AZO-based compound. For example, the persulfate-based compound may be M₂S₂O₈ (M=alkaline group 1 or NH₄⁺). More specifically, the persulfate-based compound may be at least one of potassium persulfate (PPS), ammonium persulfate (APS), and sodium persulfate (SPS) as shown in Table 1 below.

TABLE 1

| | PPS | APS | SPS |
|---|---|---|---|
| Chemical | Potassium | Ammonium | Sodium |
| name | persulfate | persulfate | persulfate |
| Structure | 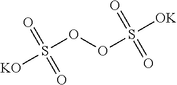 | 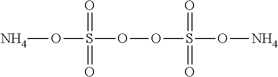 | 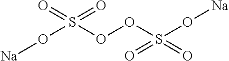 |

The peroxide-based compound may be at least one of lauroyl peroxide (LPO), benzoyl peroxide (BPO), t-butyl peroxy-2-ethylhexanoate (BPEH), 2,5-dimethyl-2,5-di(2-ethylhexanoylperoxy)hexane (DEPH), t-amylperoxy-2-ethylhexanoate (APEH), tert-butylperoxide (TBPO), tert-amylperpivalate (TAPP), di-tert-butyl diperoxyoxalate (DTBD), tert-butyl hydroperoxide (TBHP), and tert-butyl peroxybenzoate (TBPB), as shown in Table 2 below.

TABLE 2

| Initial | LPO | BPO |
|---|---|---|
| Chemical | Lauroyl | Benzoyl |
| name | Peroxide | Peroxide |
| Structure | 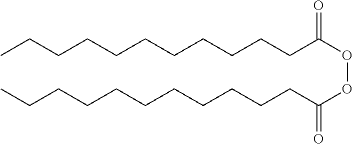 | 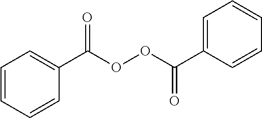 |
| Initial | BPEH | DEPH |
| Chemical | t-butyl Peroxy-2- | 2,5-Dimethyl-2,5-di (2- |
| name | ethylhexanoate | ethylhexanoylperoxy)hexane |
| Structure | 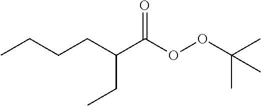 | 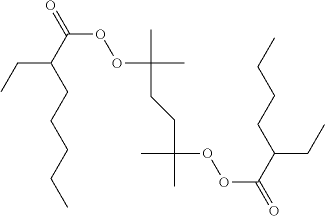 |

| Initial | APEH | TBPO | TAPP |
|---|---|---|---|
| Chemical | t-amylperoxy-2- | tert- | tert- |
| name | ethylhexanoate | Butylperoxide | Amylperpivalate |
| Structure | 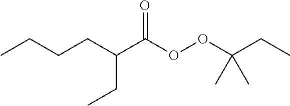 | 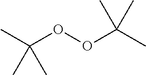 | 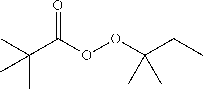 |

| Initial | DTBD | TBHP | TBPB |
|---|---|---|---|
| Chemical | Di-tert-butyl | tert-butyl | tert-butyl |
| name | diperoxyoxalate | hydroperoxide | peroxybenzoate |
| Structure | 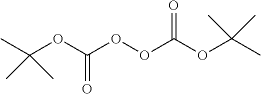 | 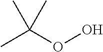 | 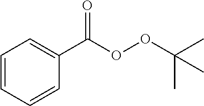 |

The Azo-based compound may be at least one of 2,2′-azobis(2,4-dimethyl valronitrile (V65), azobisisobutyronitrile (AIBN), 4,4′-azobis (4-cyanovaleric acid) (ABCA), and 1,1′ azobis (cyclohexanecarbonitrile) (ABCH), as shown in Table 3 below.

TABLE 3

| Initial | V65 | AIBN |
|---|---|---|
| Chemical | 2,2′-Azobis | Azobisiso- |
| name | (2,4-dimethyl valronitrile | butyronitrile |
| Structure | 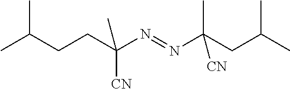 | 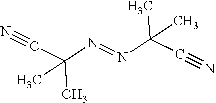 |

| Initial | ABCA | ABCH |
|---|---|---|
| Chemical | 4,4′-Azobis | 1,1′ Azobis |
| name | (4-cyanovaleric acid) | (cyclohexanecarbonitrile) |
| Structure | 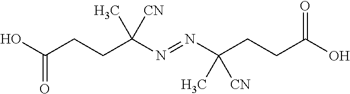 | 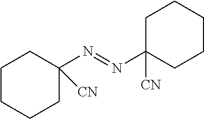 |

The second additive may be a polymer monomer containing a hydrophobic functional group while capable of an electrochemical reduction polymerization reaction. For example, the second additive may be a compound with a structure of A+B, in which A is a polymerizable functional group in charge of polymerization and B is a hydrophobic functional group. That is, the second additive may have both a polymerizable functional group and a hydrophobic functional group. Particularly, the polymerizable functional group may be an acrylic group or a methacrylic group, and the hydrophobic functional group may be any one selected from the group consisting of fluorine-substituted linear alkyl, cyclic alkyl, alkynyl, and alkenyl groups.

For example, the second additive may include any one selected from the group consisting of 2,2,2-trifluoroethyl methacrylate (TFEMA), 2,2,2-trifluoroethyl acrylate (TFEA), 1,1,1,3,3,3-hexafluoroisopropyl methacrylate (HFPMA), 2,2,3,4,4,4-hexafluorobutyl methacrylate (HFBMA), 2,2,3,3-tetrafluoropropyl methacrylate (TFPMA), 2,2,3,3,4,4,5,5-octafluoropentyl acrylate (OFPA), 2,2,3,3,4,4,4-heptafluorobutyl methacrylate (HFBM), 2,2,3,3,3-pentafluoropropyl methacrylate (PFPMA), 2,2,3,3,4,4,5,5,6,6,7,7-dodecafluoroheptyl acrylate (DDFH), 1,1,1,3,3,3-hexafluoroisopropyl acrylate (HFPA), and pentafluorophenyl acrylate (PFPA), as shown in Table 4.

TABLE 4

| Initial | TFEMA | TFEA | HFPMA |
|---|---|---|---|
| Chemical | 2,2,2-Trifluoroethyl | 2,2,2-Trifluoroethyl | 1,1,1,3,3,3- |
| name | methacrylate | acrylate | Hexafluoroisopropyl methacrylate |
| Structure | 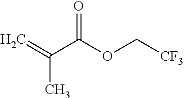 | 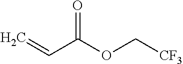 | 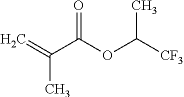 |
| Initial | HFBMA | TFPMA | OFPA |
| Chemical | 2,2,3,4,4,4- | 2,2,3,3-Tetrafluoropropyl | 2,2,3,3,4,4,5,5- |
| name | Hexafluorobutyl methacrylate | methacrylate | Octafluoropentyl acrylate |
| Structure | 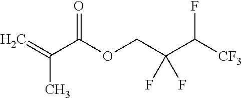 [SMILES: C=C(C)C(=O)OCC(F)(F)C(F)C(F)(F)F] | 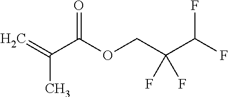 | 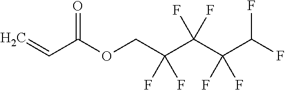 [SMILES: C=CC(=O)OCC(F)(F)C(F)(F)C(F)(F)C(F)F] |
| Initial | HFBM | PFPMA | DDFH |
| Chemical | 2,2,3,3,4,4,4 | 2,2,3,3,3-Pentafluoropropyl | 2,2,3,3,4,4,5,5,6,6,7,7- |
| name | Heptafluorobutyl methacrylate | methacrylate | Dodecafluoroheptyl acrylate |
| Structure | 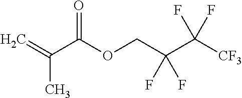 [SMILES: C=C(C)C(=O)OCC(F)(F)C(F)(F)C(F)(F)F] | 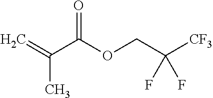 | 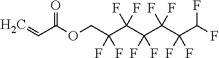 [SMILES: C=CC(=O)OCC(F)(F)C(F)(F)C(F)(F)C(F)(F)C(F)(F)C(F)F] |
| | Initial | HFPA | PFPA |
| | Chemical | 1,1,1,3,3,3-Hexafluoroisopropyl | Pentafluorophenyl |
| | name | acrylate | acrylate |
| | Structure | 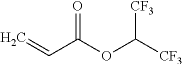 | 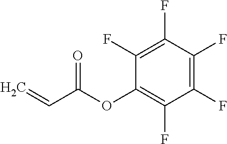 [SMILES: C=CC(=O)Oc1c(F)c(F)c(F)c(F)c1F] |

The first additive and the second additive each may be contained in a content of 0.01 wt % to 3 wt % relative to the total amount of the aqueous electrolyte composition. This content can lead to the maximization of the HER suppression effect and the minimization of SEI dissolution or loss in the aqueous electrolyte composition. Furthermore, this can achieve high capacity retention ratios, residual capacity ratios, and coulombic efficiency of aqueous secondary batteries employing the aqueous electrolyte composition.

Particularly, the first additive and the second additive may have different reduction reaction potentials. Specifically, the reduction reaction of the first additive may occur first at the anode since the reduction reaction potential of the first additive is higher than that of the second additive.

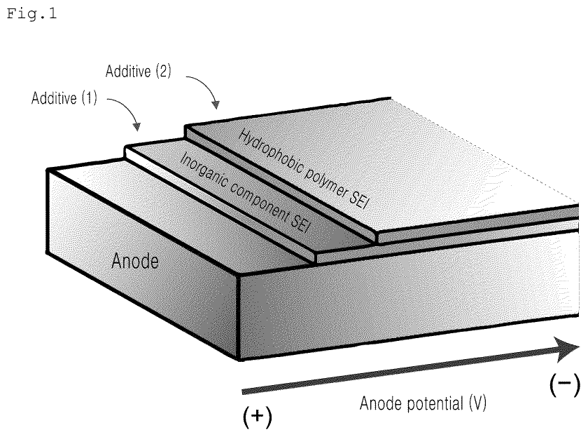

Therefore, when the potential of the anode decreases to reach the reduction potential of the first additive during the first charge of the secondary battery, the first additive undergoes reductive decomposition to form radicals, and these radicals promote the chemical decomposition of electrolyte anions and water molecules, and as a result, an SEI composed of inorganic components (LiF, Li₂O, Li₂CO₃, etc.) can be formed on the anode surface, as shown in FIG. 1.

Thereafter, when the anode potential further decreases to reach the reduction potential of the second additive, the electrochemical reduction polymerization of the second additive is initiated, and as a result, a hydrophobic polymer SEI formed by the second additive can be formed on the inner layer SEI formed by the first additive, as shown in FIG. 1. The hydrophobic polymer SEI can minimize the dissolution or loss of the inner layer SEI composed of inorganic components by suppressing the penetration of water molecules. That is, a double-structured SEI composed of an inner inorganic layer and an outer hydrophobic organic polymer layer can be formed on the anode e surface through a particular combination of the first additive and the second additive.

The inner SEI composed of inorganic components effectively inhibits the electron transfer due to the high electrical insulation of the inorganic materials, and thus can suppress an additional reduction reaction of the electrolyte. The outer SEI composed of the hydrophobic polymer component effectively can inhibit the access and penetration of free water molecules, thereby preventing the inner SEI composed of inorganic components from being dissolved or lost in the electrolyte. As such, both HER suppression and dissolution/loss inhibition effects can be achieved through the synergistic effect between two types of additives with different roles.

Meanwhile, the aqueous electrolyte may be at least one of a highly concentrated water-in-salt electrolyte (WiSE), a water-in-bisalt electrolyte (WiBSE), and a hybrid electrolyte using an organic compound as a co-solvent.

Specifically, the aqueous electrolyte may be an aqueous solution of an MX salt, in which M may be an alkaline group 1 or alkaline group 2 metal and X may be sulfonamide (R₁—SO₂—N—SO₂—R₂—: FSI⁻TFSI⁻, BETI⁻, etc.), perchlorate (ClO₄⁻), acetate (CH₃COO⁻), nitrate (NO₃⁻), Nitrite (NO₂⁻), sulfate (SO⁻²), sulfite (SO₃⁻), trifluoromethansulfonate (CF₃SO₃⁻═OTf⁻), or the like.

With respect to the MX concentration, the molar ratio of MX/H₂O may be 1/10 to 1/2.

Meanwhile, the aqueous electrolyte may include an organic compound as a co-solvent. For example, the organic compound may be any one of dimethyl sulfoxide, sulfolane (SL), acetonitrile, and trimethyl phosphate. With respect to the content of the organic compound, the molar ratio of water/organic solvent may be 1/10 to 10/1.

An anode active material for the aqueous secondary battery may be LiMn₂O₄, LiCoO₂, LiFePO₄, LiNiₓCO_{y}Mn_{z}O₂ (x+y+z=1), LiNi_{0.5}Mn_{1.5}O₄, Na₃V₂(PO₄)₃, K₃V₂(PO₄)₃, Prussian blue, and a derivative, conductive polymer, or radical polymer thereof. The anode active material for the aqueous secondary battery may be Li₄Ti₅O₁₂, TiO₂, WO₃, sulfur, aluminum, or a carbon body, but is not limited thereto.

Hereinafter, the present disclosure will be described in detail with reference to exemplary embodiments. However, the following exemplary embodiments are merely for illustrating the present invention and are not intended to limit the scope of the present invention.

### EXAMPLES

### Preparation of Aqueous Electrolyte Compositions

Aqueous electrolyte compositions were prepared that had the compositions as shown in Table 5 below.

TABLE 5

| | Aqueous | First | Second |
|---|---|---|---|
| | electrolyte | additive | additive |
| Example 1 | WiSE⁽¹⁾ | PPS⁽²⁾ 1 wt % | DDFH⁽³⁾ 1 wt % |
| Com. Example 1 | WiSE | — | — |
| Com. Example 2 | WiSE | PPS 1 wt % | — |
| Com. Example 3 | WiSE | — | DDFH 1 wt % |
| Example 2 | WiBSE⁽⁴⁾ | PPS 1 wt % | DDFH 1 wt % |
| Com. Example 4 | WiBSE | — | — |
| Com. Example 5 | WiBSE | PPS 1 wt % | — |
| Com. Example 6 | WiBSE | — | DDFH 1 wt % |
| Example 3 | Hybrid | PPS 1 wt % | DDFH 1 wt % |
| | electrolyte⁽⁵⁾ | | |
| Com. Example 7 | Hybrid | — | — |
| | electrolyte | | |
| Com. Example 8 | Hybrid | PPS 1 wt % | — |
| | electrolyte | | |
| Com. Example 9 | Hybrid | — | DDFH 1 wt % |
| | electrolyte | | |
| Example 4 | WiSE | SPS⁽⁶⁾ 1 wt % | DDFH 1 wt % |
| Example 5 | WiSE | BPEH⁽⁷) 1 wt % | DDFH 1 wt % |
| Example 6 | WiSE | ABCA⁽⁸⁾ 1 wt % | DDFH 1 wt % |
| Example 7 | WiSE | PPS 1 wt % | HFBM⁽⁹⁾ 1 wt % |
| Com. Example 10 | WiSE | PPS 1 wt % | MMA⁽¹⁰⁾ 1 wt % |

⁽¹⁾WiSE: Aqueous solution of LiTFSI (lithium bis(fluorosulfonly)imide, molarity of 21 m)
⁽²⁾PPS: Potassium persulfate
⁽³⁾DDFH: 2,2,3,3,4,4,5,5,6,6,7,7-Dodecafluoroheptyl acrylate
⁽⁴⁾WiBSE: Aqueous solution of LiTFSI (molarity of 20 m) and LiBETI (molarity of 8 m)
⁽⁵⁾Hybrid electrolyte: LiTFSI (molarity of 3.6 m) + H₂O/SL (dimethyl sulfoxide, sulfolane) 1/1 by mol
⁽⁶⁾SPS: Sodium persulfate
⁽⁷⁾BPEH: t-Butyl peroxy-2-ethylhexanoate
⁽⁸⁾ABCA: 4,4′-Azobis(4-cyanovaleric acid)
⁽⁹⁾HFBM: 2,2,3,3,4,4,4-Heptafluorobutyl methacrylate
⁽¹⁰⁾MMA (monomer without hydrophobic functional group):Methyl methacrylate

### EXPERIMENTAL EXAMPLES

### Electrolyte and Battery Performance Evaluation and Analysis

### (1) Comparison of Electrochemical Stability Window (ESW) Through Cyclic Voltammetry (CV) Measurement

To compare the ESW of the electrolyte compositions prepared in Example 1 and Comparative Examples 1 to 3 according to Table 5 above, cyclic voltammetry (CV) measurements were conducted at a scan rate of 10 mV/s within the open circuit voltage range of −2.0 V by using a three-electrode system (Glassy carbon working electrode, Ag/AgCl reference electrode, and Pt auxiliary electrode). The initial scan direction started toward the reduction potential.

The reduction current observed between −1.5 V and −2.0 V was due to a reductive decomposition reaction (HER) of water, and the magnitude of the reduction current is proportional to the extent of HER.

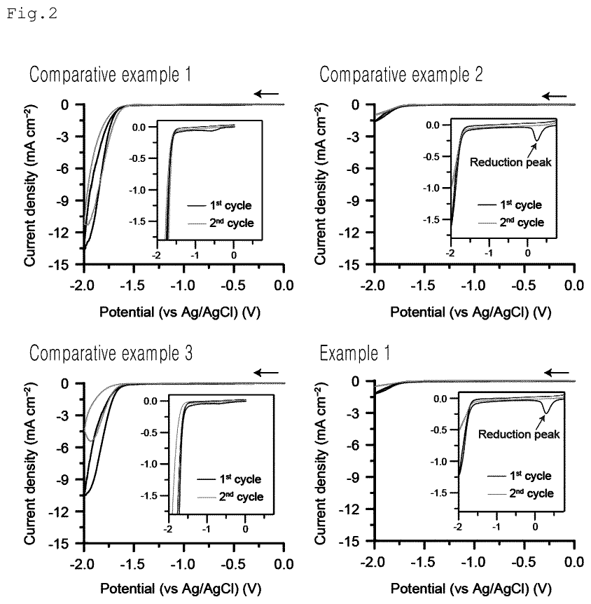

Referring to FIG. 2, in Comparative Example 1 with no additive introduced, a very large reduction current (>10 mA cm⁻²) was observed during the first cycle and a large current was still generated during the second cycle.

In Comparative Example 2 with 1 wt % of PPS introduced, a small reduction peak was observed in the 0 V to 0.5 V range during the first cycle and, thereafter, the reduction current in the-1.5 V to-2.0 V range was significantly decreased compared to Comparative Example 1. The reason is presumed that SEI was formed on the electrode surface as a result of a reduction reaction (0 V to 0.5 V range) of the PPS additive, and this SEI suppressed HER of WiSE.

In Comparative Example 3 with 1 wt % of DDFH introduced, the reduction current in the −1.5 V to −2.0 V range was decreased compared to Comparative Example 1. The reason is presumed that SEI was formed on the electrode surface as a result of a reduction reaction of the DDFH additive, and this SEI suppressed HER of WiSE. The reduction reaction of the DDFH additive showed no distinct peak, which was presumed to be due to slow kinetics of the corresponding reaction.

In Example 1 with 1 wt % of both PPS and DDFH introduced, the reduction current was most significantly decreased compared to Comparison 2 or 3 employing the PPS or DDFH additive alone as well as Comparative Example 1. In other words, it can be seen that the use of both two additives can suppress the HER reaction more effectively and extend the ESW of the corresponding electrolyte.

### (2) Evaluation of Room-Temperature Life Cycle Characteristics of LMO/LTO Batteries

Coin-type batteries were fabricated using the electrolytes of the examples and comparative examples, LiMn₂O₄ (LMO) cathode, Li₄Ti₅O₁₂ (LTO) anode, and a glass fiber separator. The fabricated batteries were charged and discharged at a constant current of 1 C in the 2.0 to 2.7 V range at room temperature (25° C.).

### (2-1) Room-Temperature Life Cycle Characteristics of LTO/LMO: Example 1 vs Comparative Examples 1 to 3

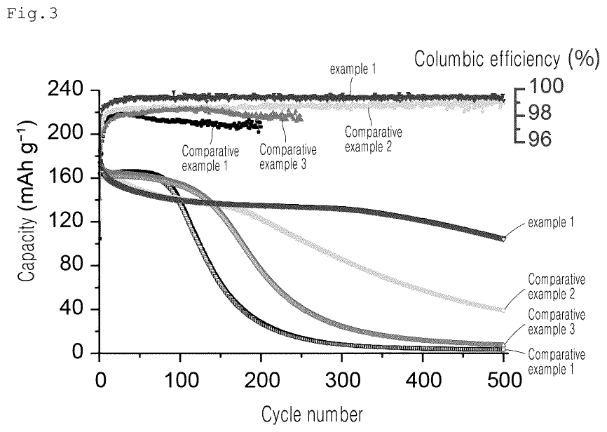

The room-temperature life charge-discharge results of LMO/LTO batteries employing WiSE of Example 1 and Comparative Examples 1 to 3 are shown in FIG. 3. Also, the capacity retention ratio, defined as the ratio of discharge capacity after 500 cycles of charge and discharge to the initial capacity, is presented in Table 6 below. Referring to FIG. 2, the battery employing the electrolyte composition of Example 1 showed a high capacity of at least 100 mAhg-1 after 500 charge/discharge cycles, whereas the batteries employing the electrolyte compositions of Comparative Examples 1 to 3 showed serious deteriorations. Referring to Table 6, the capacity retention ratio after 500 charge/discharge cycles decreased in the order of Example 1>Comparative Example 2>Comparative Example 3>Comparative Example 1.

The Coulombic efficiency presented in the upper right of FIG. 3 also showed the same order. In other words, the battery employing both two additives together showed excellent life cycle characteristics compared to the battery employing no additive and the batteries employing the additives alone.

### (2-2) Room-Temperature Life Cycle Characteristics of LTO/LMO: Example 2 vs Comparative Examples 4 to 6

LMO/LTO batteries employing the WiBSE of Example 2 and Comparative Examples 4 to 6 were evaluated in the same manner as in the preceding evaluation case (2-1), and the capacity retention ratio after 500 charge/discharge cycles is shown in Table 6. The capacity retention ratio followed in the order of Example 2>Comparative Example 5>Comparative Example 6>Comparative Example 4. Also in the WiBSE, the battery employing both two additives together showed excellent life cycle characteristics compared to the battery employing no additive and the batteries employing the additives alone.

### (2-3) Room-Temperature Life Cycle Characteristics of LTO/LMO: Example 3 vs Comparative Examples 7 to 9

LMO/LTO batteries employing the hybrid electrolytes of Example 3 and Comparative Examples 7 to 9 were evaluated in the same manner as in the preceding evaluation case (2-1), and the capacity retention ratio after 500 charge/discharge cycles is shown in Table 6. The capacity retention ratio followed in the order of Example 3>Comparative Example 8>Comparative Example 9>Comparative Example 7. Also in the hybrid electrolytes, the battery employing both two additives together showed excellent life cycle characteristics compared with the battery employing no additive and the batteries employing the additives alone.

### (2-4) Room-Temperature Life Cycle Characteristics of LTO/LMO: Examples 4-6

LMO/LTO batteries employing the electrolytes of Examples 4 to 6, obtained by replacing only PPS in the electrolyte of Example 1 with SPS, BPEH, and ABCA, respectively, were evaluated in the same manner as in the preceding evaluation case (2-1), and the capacity retention ratio after 500 charge/discharge cycles is shown in Table 6.

The capacity retention ratio was not significantly different between Example 1 and Examples 4 to 6. It can be seen that similar characteristics are achieved even when the cation of a persulfate is changed to Nat or a peroxide- or azo-based compound is used instead of persulfate. In other words, compounds that form radicals through reductive decomposition can be used as the first additive.

### (2-5) Room-Temperature Life Cycle Characteristics of LTO/LMO: Example 7 vs Comparative Example 10

LMO/LTO batteries employing the electrolytes of Example 7 and Comparative Example 10, obtained by replacing only DDFH in the electrolyte of Example 1 with HFBM and MMA, respectively, were evaluated in the same manner as in the preceding evaluation case (2-1), and the capacity retention ratio after 500 charge/discharge cycles is shown in Table 5.

Example 7 and Example 1 showed similar capacity retention rations, but Comparative Example 10 showed a significantly lower capacity retention ratio. In other words, it can be seen that the presence or absence of a hydrophobic functional group has a significant effect on battery performance.

### (3) Evaluation of High-Temperature Storage Characteristics of LMO/LTO Batteries

LMO/LTO batteries fabricated in the same manner as in the room-temperature life cycle evaluation were charged and discharged three times at a constant current of 1 C in the 2.0 to 2.7 V range at room temperature (25° C.), and then the fully charged (SOC 100) batteries were stored at 60° C. for 1 day. Thereafter, the residual capacity ratio, defined as the ratio of the residual capacity to the capacity before high-temperature storage, is presented in Table 6.

### (3-1) Evaluation of High-Temperature Storage Characteristics of LMO/LTO Batteries: Example 1 VS Comparative Examples 1 to 3

The residual capacity ratio followed in the order of Example 1>Comparative Example 2>Comparative Example 3>Comparative Example 1. As such, the battery employing both two additives together showed excellent high-temperature storage characteristics compared to the battery employing no additive and the batteries employing the additives alone.

### (3-2) Evaluation of High-Temperature Storage Characteristics of LMO/LTO Batteries: Examples 4-6

The residual capacity ratio was not significantly different between Example 1 and Examples 4 to 6.

### (3-3) Evaluation of High-Temperature Storage Characteristics of LMO/LTO Batteries: Example 7 vs Comparative Example 10

Example 7 and Example 1 showed similar residual capacity ratios, but Comparative Example 10 showed a significantly lower residual capacity ratio.

TABLE 6

| | Capacity retention ratio | Residual capacity |
|---|---|---|
| | (%)/Room-temperature life | ratio (%)/Storage |
| | cycle after 500 cycles | for 1 day at 60° C. |
| Example 1 | 77.3 | 50.5 |
| Com. Example 1 | 2.1 | 0 |
| Com. Example 2 | 24.3 | 17.0 |
| Com. Example 3 | 4.3 | 15.8 |
| Example 2 | 85.3 | — |
| Com. Example 4 | 3.0 | — |
| Com. Example 5 | 31.8 | — |
| Com. Example 6 | 48.0 | — |
| Example 3 | 90.7 | — |
| Com. Example 7 | 65.3 | — |
| Com. Example 8 | 89.1 | — |
| Com. Example 9 | 85.8 | — |
| Example 4 | 76.8 | 49.6 |
| Example 5 | 78.0 | 50.6 |
| Example 6 | 76.5 | 47.1 |
| Example 7 | 72.2 | 46.8 |
| Com. Example 10 | 11.0 | 8.9 |

The features, structures, effects, and the like described in the above exemplary embodiments are included in at least one exemplary embodiment of the present disclosure and are not necessarily limited to one exemplary embodiment. Furthermore, the features, structures, effects, and the like illustrated in each exemplary embodiment may be combined or modified into other exemplary embodiments by those skilled in the art to which the exemplary embodiments pertain. Accordingly, the contents related to such combination or modification should be interpreted as being included in the scope of the disclosure. The present disclosure has been described mainly with reference to exemplary embodiments, but these exemplary embodiments are merely exemplified and do not limit the present disclosure. It will be understood by those skilled in the art that various modifications and applications, not illustrated above, may be made without departing from the substantial features of the present disclosure. For example, respective elements specifically shown in the exemplary embodiments can be modified and implemented. It should be interpreted that differences related to such modifications and applications are included in the scope of the present disclosure defined in the appended claims.

### INDUSTRIAL APPLICABILITY

The present invention relates to an aqueous electrolyte for an aqueous secondary battery, containing two types of additives, wherein the formation of a double-layered SEI layer is expected by mixing of two types of additives in the aqueous electrolyte composition, and this double-layered SEI layer can lead to blocking of HER and minimizing of SEI dissolution/lost, thereby achieving high capacity retention ratio, residual capacity ratio, and columbic efficiency. Accordingly, the aqueous electrolyte of the present invention is highly industrially applicable.

1. An aqueous electrolyte composition comprising:
a first additive: a second additive; and an aqueous electrolyte,
wherein the first additive and the second additive have different reduction potentials.

2. The aqueous electrolyte composition of claim 1, wherein the first additive is at least one selected from the group consisting of a persulfate-based compound, a peroxide-based compound, and an AZO-based compound.

3. The aqueous electrolyte composition of claim 1, wherein the first additive includes any one selected from the group consisting of potassium persulfate (PPS), ammonium persulfate (APS), sodium persulfate (SPS), lauroyl peroxide (LPO), benzoyl peroxide (BPO), t-butyl peroxy-2-ethylhexanoate (BPEH), 2,5-dimethyl-2,5-di (2-ethylhexanoylperoxy) hexane (DEPH), t-amylperoxy-2-ethylhexanoate (APEH), tert-butylperoxide (TBPO), tert-amylperpivalate (TAPP), di-tert-butyl diperoxyoxalate (DTBD), tert-butyl hydroperoxide (TBHP), tert-butyl peroxybenzoate (TBPB), 2,2′-azobis (2,4-dimethyl valronitrile (V65), azobisisobutyronitrile (AIBN), 4,4′-azobis (4-cyanovaleric acid) (ABCA), and 1,1′ azobis(cyclohexanecarbonitrile) (ABCH).

4. The aqueous electrolyte composition of claim 1, wherein the second additive has a polymerizable functional group and a hydrophobic functional group.

5. The aqueous electrolyte composition of claim 1, wherein the polymerizable functional group is an acryl group or a methacryl group, and
the hydrophobic functional group is any one selected from the group consisting of fluorine-substituted linear alkyl, cyclic alkyl, alkynyl, and alkenyl groups

6. The aqueous electrolyte composition of claim 1, wherein the second additive includes any one selected from the group consisting of 2,2,2-trifluoroethyl methacrylate (TFEMA), 2,2,2-trifluoroethyl acrylate (TFEA), 1,1,1,3,3,3-hexafluoroisopropyl methacrylate (HFPMA), 2,2,3,4,4,4-hexafluorobutyl methacrylate (HFBMA), 2,2,3,3-tetrafluoropropyl methacrylate (TFPMA), 2,2,3,3,4,4,5,5-octafluoropentyl acrylate (OFPA), 2,2,3,3,4,4,4-heptafluorobutyl methacrylate (HFBM), 2,2,3,3,3-pentafluoropropyl methacrylate (PFPMA), 2,2,3,3,4,4,5,5,6,6,7,7-dodecafluoroheptyl acrylate (DDFH), 1,1,1,3,3,3-hexafluoroisopropyl acrylate (HFPA), and pentafluorophenyl acrylate (PFPA).

7. The aqueous electrolyte composition of claim 1, wherein the aqueous electrolyte is at least one of a highly concentrated water-in-salt electrolyte (WiSE), a water-in-bisalt electrolyte (WiBSE), and a hybrid electrolyte using an organic compound as a co-solvent.

8. The aqueous electrolyte composition of claim 1, wherein the first additive and the second additive each are contained in a content of 0.01 wt % to 3 wt % relative to the total amount of the aqueous electrolyte composition.

9. An aqueous secondary battery comprising the aqueous electrolyte composition according to claim 1.
